(19) United States
(12) Patent Application Publication
(10) Pub. No.: US 2015/0063789 A1
(43) Pub. Date: Mar. 5, 2015

(54) BROADCAST DEVICE, BROADCAST SYSTEM, AND ASSOCIATED BROADCAST METHOD

(71) Applicant: Wistron Corporation, New Taipei City (TW)

(72) Inventor: Chin-Kun Tsai, New Taipei City (TW)

(73) Assignee: Wistron Corporation, New Taipei City (TW)

(21) Appl. No.: 14/105,692

(22) Filed: Dec. 13, 2013

(30) Foreign Application Priority Data
Aug. 27, 2013 (TW) 102130653

(51) Int. Cl. G06K 9/00; H04N 5/91

(52) U.S. Cl. CPC G06K 9/00221; H04N 5/91
USPC 386/343

(57) ABSTRACT

A broadcast device, a broadcast system and an associated broadcast method are provided. The broadcast method includes the steps of: broadcasting a multimedia bitstream; detecting a first biological feature; updating contents of a database according to a broadcasting status of the multimedia bitstream when the first biological feature satisfies a first trigger condition; and broadcasting the multimedia bitstream according to the contents of the database when the first biological feature satisfies a first recovery condition.

This application claims the benefit of Taiwan application Serial No. 102130653, filed Aug. 27, 2013, and the subject matter of which is incorporated herein by reference.

### BACKGROUND OF THE INVENTION

1. Field of the Invention

The invention relates in general to a broadcast device, a broadcast system and an associated broadcast method, and more particularly to a broadcast device, a broadcast system and an associated broadcast method of detecting biological features.

2. Description of the Related Art

With the development of the technology, home video-audio devices are often installed in living rooms of many people. These video-audio devices provide higher comfort and degree of freedom to users.

Taking the movie watching as an example, when the user is watching the movie in the theater, he or she has to finish watching a movie without interruption. Otherwise, contents of the movie will be missed. However, when the user watches the movie at home, the user can freely select to pause the movie to walk or process other things at any time.

The audio-visual entertainments in the living room are diversified day by day, and there are more and more multimedia broadcast devices providing the services. The home video-audio devices, such as a blue-ray disc (hereinafter, BD) drive, a television, a set top box, and external speaker and the like, often provide accessory remote controllers for controlling. However, this also represents that the user needs to select a suitable remote controller among various remote controllers according to his/her required function, so that the operation can be correctly performed.

For example, when the user watches a BD movie at home and needs to pause the BD movie, the user has to find correct remote controller for the BD drive and pause the broadcasting of the BD movie through the pause key of the remote controller. When the user comes back to the living room and wishes to continue watching the BD movie, the user needs to select the correct remote controller again and cancel the pause function.

As mentioned hereinabove, when there are many multimedia broadcast devices, the user may spend time to find the correct remote controller. In other words, selection of too many remote controllers brings control complexities, and even trouble to the user.

### SUMMARY OF THE INVENTION

According to a first aspect of the present invention, a broadcast device including a broadcast unit, a storage unit, a detecting unit and a control unit is provided. The broadcast unit broadcasts a multimedia bitstream. The storage unit stores a database. The detecting unit is electrically connected to the broadcast unit and detects a first biological feature. The control unit is electrically connected to the broadcast unit and the detecting unit. The control unit updates contents of the database according to a broadcasting status of the multimedia bitstream when the detected first biological feature satisfies a first trigger condition, and controls the broadcast unit to broadcast the multimedia bitstream according to the contents of the database when the detected first biological feature satisfies a first recovery condition.

According to a second aspect of the present invention, a broadcast system including a detecting device and a broadcast device is provided. The detecting device detects and transmits a first biological feature. The broadcast device includes a receiving unit, a broadcast unit, a storage unit and a control unit. The receiving unit is in communication with the detecting device and receives the detected first biological feature. The broadcast unit broadcasts a multimedia bitstream. The storage unit stores contents of a database. The control unit is electrically connected to the receiving unit, the broadcast unit and the detecting unit. The control unit updates contents of the database according to a broadcasting status of the multimedia bitstream when the detected first biological feature satisfies a first trigger condition; and controls the broadcast unit to broadcast the multimedia bitstream according to contents of the database when the detected first biological feature satisfies a first recovery condition.

According to a third aspect of the present invention, a broadcast method applied to a broadcast device is provided. The broadcast method includes the steps of: broadcasting a multimedia bitstream; detecting a first biological feature; updating contents of a database according to a broadcasting status of the multimedia bitstream when the detected first biological feature satisfies a first trigger condition; and broadcasting the multimedia bitstream according to contents of the database when the first detected biological feature satisfies a first recovery condition.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram illustrating a broadcast device according to an embodiment of the present invention;

FIG. 2A is a schematic diagram illustrating frame components contained in a group of pictures (GOP);

FIG. 2B is a schematic diagram illustrating time parameters corresponding to the frames in the GOP;

FIG. 3 is a flow chart showing that a user database is created using a learning process;

FIG. 4A is a schematic diagram illustrating that the broadcast device is maintaining the user database;

FIG. 4B is a schematic diagram illustrating that the broadcast device is maintaining the movie database;

FIG. 5 is a schematic diagram illustrating multiple users operating the broadcast device according to the embodiment of the present invention;

FIG. 6A is a schematic diagram illustrating that a user A leaves first in a case that the users A, B and C are watching a first movie together;

FIG. 6B is a schematic diagram corresponding to the status of FIG. 6A and showing that the movie database is updated;

FIG. 6C is a schematic diagram corresponding to the status of FIG. 6A and showing that the user database is updated;

FIG. 7A is a schematic diagram following the condition of FIG. 6A and showing that the user B leaves;

FIG. 7B is a schematic diagram corresponding to the status of FIG. 7A and showing that the movie database is updated;

FIG. 7C is a schematic diagram corresponding to the status of FIG. 7A and showing that the user database is updated;

FIG. 8A is a schematic diagram following the condition of FIG. 7A and assuming that the user A is back to the seat;

FIG. 8B is a schematic diagram corresponding to the status of FIG. 8A and showing that the movie database is updated;

FIG. 8C is a schematic diagram corresponding to the status of FIG. 8A and showing that the user database is updated;

FIG. 9A is a schematic diagram following the condition of FIG. 7A and assuming that the user C leaves;

FIG. 9B is a schematic diagram corresponding to the status of FIG. 9A and showing that the movie database is updated;

FIG. 9C is a schematic diagram corresponding to the status of FIG. 9A and showing that the user database is updated;

FIG. 10A is a schematic diagram following the condition of FIG. 9A and assuming that the user B is back to the seat;

FIG. 10B is a schematic diagram corresponding to the status of FIG. 10A and showing that the broadcast device displays a prompt frame through the user interface;

FIG. 10C is a schematic diagram corresponding to the status of FIG. 10A and showing that the movie database is updated;

FIG. 10D is a schematic diagram corresponding to the status of FIG. 10A and showing that the user database is updated;

FIG. 11A is a schematic diagram following the condition of FIG. 10A and assuming that the user A again watches the first movie I;

FIG. 11B is a schematic diagram corresponding to the status of FIG. 11A and showing that the broadcast device displays the prompt frame;

FIG. 11C is a schematic diagram corresponding to the status of FIG. 11A and showing that the movie database is updated;

FIG. 11D is a schematic diagram corresponding to the status of FIG. 11A and showing that the user database is updated;

FIG. 12A is a schematic diagram following the condition of FIG. 10A and showing that the users A and C again watch the first movie concurrently;

FIG. 12B is a schematic diagram corresponding to the status of FIG. 12A and showing that the broadcast device displays the prompt frame through the user interface;

FIG. 12C is a schematic diagram corresponding to the status of FIG. 12A and showing that the movie database is updated;

FIG. 12D is a schematic diagram corresponding to the status of FIG. 12A and showing that the user database is updated;

FIG. 13 is a flow chart showing a broadcast method of the present invention;

FIG. 14 is a schematic diagram illustrating that the broadcast device is maintaining the movie database;

FIG. 15 is a schematic diagram illustrating that the broadcast device is maintaining the user database; and

FIG. 16 is a schematic diagram illustrating a detecting device working in conjunction with the broadcast device.

### DETAILED DESCRIPTION OF THE INVENTION

As mentioned hereinabove, the control method of the multimedia broadcast device still has to be improved so as to provide a more convenient operation way for the user. Thus, the present invention wishes to simplify users' pause/re-broadcast control to the remote controller so that the broadcast of bitstream can be achieved by a more natural human reaction.

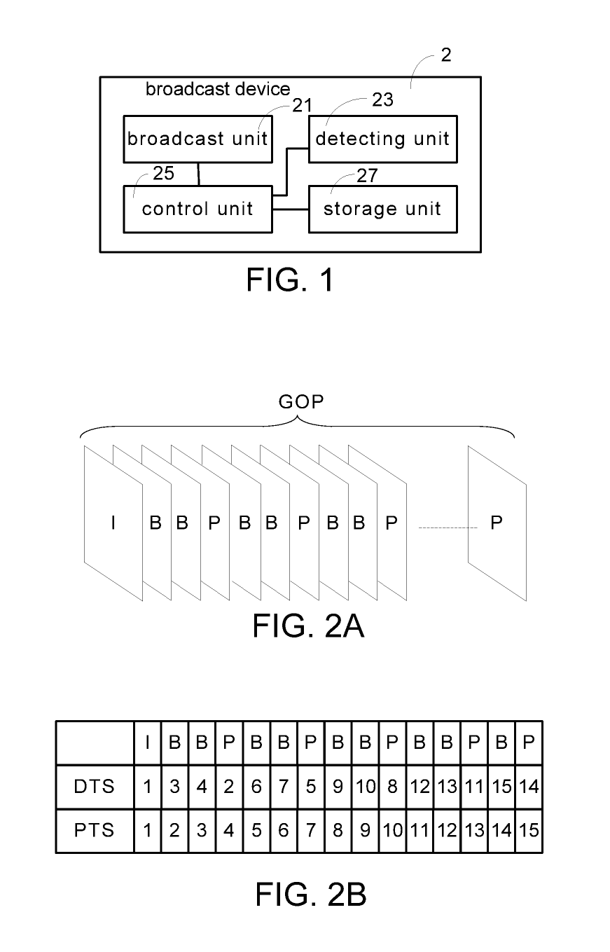

FIG. 1 is a block diagram illustrating a broadcast device 2 according to an embodiment of the present invention. Referring to FIG. 1, the broadcast device 2 includes a broadcast unit 21, a detecting unit 23, a control unit 25 and a storage unit 27. The control unit 25 is electrically connected to the broadcast unit 21, the detecting unit 23 and the storage unit 27.

According to the present invention, the detecting unit 23 with biological feature detecting function is utilized to assist the user in controlling the broadcast device 2. The detecting unit 23 of the present invention actively detects the biological features corresponding to the user and the users need not to intentionally control the broadcast device 2. Instead, the detecting unit 23 operates in an active detecting mode for detecting what operation the users need. That is, the detecting unit 23 continuously and actively detects whether a biological feature is present within a detecting range.

Incidentally, the control unit 25 automatically controls the broadcast unit 21 to perform user's personalized operation according to whether biological features are detected by the detecting unit 23. That is, the user needs not to deliberately control the function of the broadcast device 2.

The biological feature advantageously possesses the uniqueness, universality, permanence, undeceive ability, convenience, testability and the like, and is a relatively effective way for identification. The detecting unit 23 in the broadcast device 2 can actively detect the biological features corresponding to the user who does not pay attention to the detecting. Thereafter, the control unit 25 determines whether the biological feature matches to a predetermined user account. The biological features suitable for the active detecting include the iris recognition feature, the facial recognition feature and the like. For the sake of description, the facial recognition feature will be used in the following embodiments.

The storage unit 27 in the broadcast device 2 provides two sets of databases (a movie database and a user database) corresponding to broadcasting statuses of the multimedia bitstream. The movie database stores movie-associated information and the broadcasting statuses. The user database stores user accounts, biological features and broadcasting statuses of the movie watched by the user. Herein, the broadcasting statuses represents statuses of the movie watched by each user and are represented by time parameters. How the broadcast device 2 controls the broadcast function according to the user's biological feature will be further described in the following.

FIG. 2A is a schematic diagram illustrating frames contained in a group of pictures (hereinafter, GOP). Moving picture experts group (hereinafter, MPEG) and H.264 standards adopt the GOP to represent video data. The frames contained in the typical GOP include an intra frame (hereinafter, I frame), a predictive frame (hereinafter, P frame) and a bi-directional frame (hereinafter, B frame).

When the I frame is decoded, it is unnecessary to consider the relationship between the I frame and other frames, and only its own data is encoded. Therefore, the I frame stores a complete frame. In addition, when the I frame is decoded, it is unnecessary to refer to other frames, and the I frame may also be decoded solely. Therefore, the I frame has the click-to-broadcast property on the time axis and thus serves as the reference point for decoding. On the other hand, the B frame and the P frame refer to contents of the I frame.

In short, one GOP has two I frames, plural P frames and plural B frames. The three types of frames in the GOP may be arranged in various orders. The relevance and the decoding methods of the three types of frames are well known in the art, and will not be described in detail.

One video bitstream contains multiple GOPs each utilizing corresponding time parameters to represent broadcast order. The time parameters corresponding to the frames in the GOP may be classified into two types, a presentation time stamp (hereinafter, PTS) and a decoding time stamp (hereinafter, DTS).

FIG. 2B is a schematic diagram illustrating time parameters corresponding to the frames in the GOP. Referring to FIG. 2B, the second row of the table represents the DTS of each frame, and the third row of the table represents the PTS of each frame.

The PTS represents the actual broadcasting order of each frame in the GOP. However, because the I, B and P frames need to refer to one other, the actual decoding order is different from the actual broadcasting order. As shown in FIG. 2B, the corresponding DTS and PTS of each frame in the GOP are not necessarily identical.

As mentioned hereinabove, the I frame in each GOP in the video bitstream has its corresponding DTS. Once the DTS is obtained, position of the to-be-broadcasted GOP and the I frame can be correspondingly obtained. Therefore, if the user needs to pause the broadcasting of the movie due to a leave, the control unit 25 can control the storage unit 27 to store the DTS. In addition, when the movie is broadcasted subsequently, the corresponding GOP is again found according to the stored DTS, and then the movie contents are broadcasted from the I frame of the GOP.

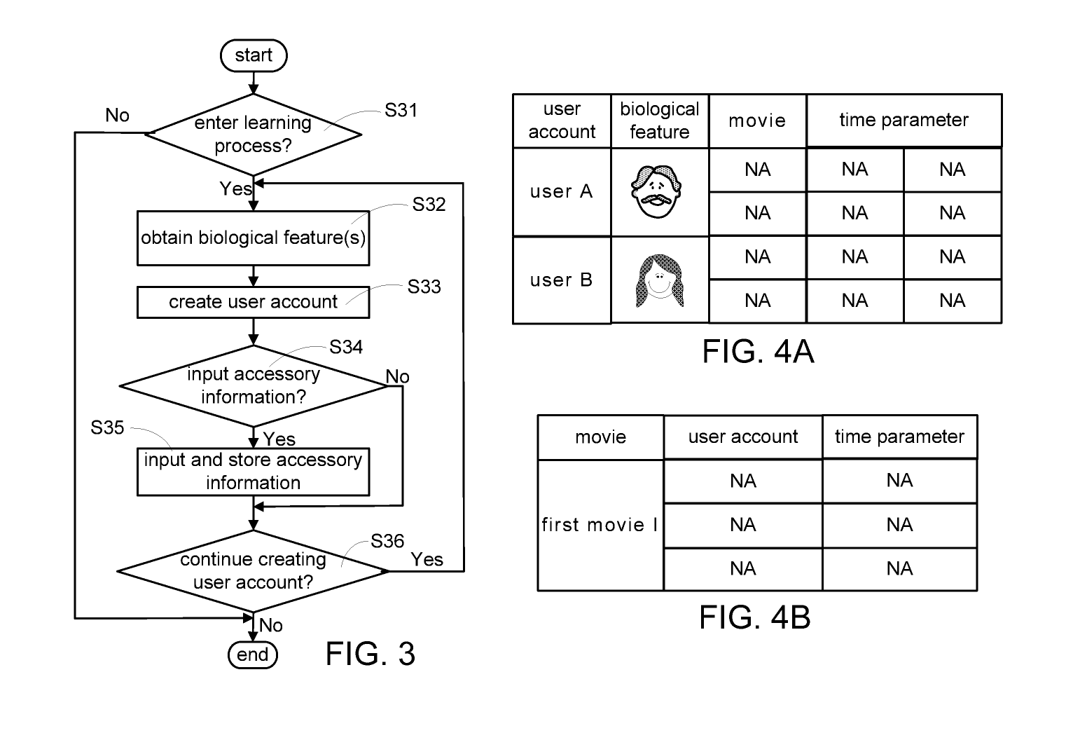

FIG. 3 is a flow chart showing that a user database is created using a learning process. Referring to FIG. 3, it is firstly determined whether the learning process needs to be entered (step S31). The learning process may be activated through a prompt frame in conjunction with operation of the remote controller, so that the user can determine whether to enter the learning process or not.

If the determination result of the step S31 is negative, the learning process immediately terminates. If the determination result of the step S31 is affirmative, the detecting unit 23 is used to detect and obtain the user's biological feature(s) (step S32). In addition, the user account is created (step S33). When the user account is being created, the user's biological feature is also stored. Thereafter, the user's identification can be determined according to the biological feature(s).

In a further application, accessory information corresponding to each user account may also be input and stored according to the user's requirement. Therefore, it is then determined whether to input the accessory information or not (step S34). The accessory information may include user name, gender, birthday, preferred movie type, and the like. Whether the accessory information is created or not and the type of the accessory information may be defined according to the application of the broadcast device, or the user's requirement.

If the determination result of the step S34 is affirmative, the accessory information corresponding to the user account is stored in the user database according to user's input data (step S35).

On the contrary, if the user thinks that it is unnecessary to create the accessory information, the learning process of the user terminates, and it is determined whether the learning process of a next user needs to be performed (step S36). If the determination result of the step S36 is negative, then the learning process ends. If the determination result of the step S36 is affirmative, the step S32 is executed again.

According to FIG. 3, it is obtained that the learning process can be repeatedly performed on various users so that the corresponding relationships between multiple user accounts and multiple sets of biological features are created. In addition, various operation habits or preferences of users may be stored in the database as the accessory information.

In the following embodiments, the user's facial profile serves as an example of the biological feature. In the practical application, however, the user's biological feature is not restricted to the facial profile. Furthermore, when the broadcast device performs the facial profile matching, it is possible to calculate and obtain feature parameters first, and proceed with identification matching subsequently. Furthermore, the facial recognition feature may be represented via multiple sets of feature values/parameters, and is only schematically referred to as the biological feature. The determination and presentation of the biological feature may be modified by those skilled in the art.

The present invention provides mark function as bookmark of the multimedia bitstream in the movie database and the user database. Usage of the user database and the movie database will be described with reference to FIGS. 4A and 4B, respectively. In FIGS. 4A and 4B, NA represents the “not available” status.

FIG. 4A is a schematic diagram illustrating how the broadcast device maintains the user database. Referring to FIG. 4A, the user account is the main object to be maintained in the user database. The biological feature corresponding to each user is recorded in each user account. In addition, when the user is not able to finish watching a movie, the movie that has not been finish watched by the user and the pause time are recorded. When there are multiple movies that have not been finish watched by the user (unfinished watching movies), corresponding time parameters may be recorded using an indicator list.

Each user has an account. The facial recognition feature is obtained after photographing each user, and the user's information is stored in the system. In FIG. 4A, it is assumed that the broadcast device creates the user accounts for the user A and the user B in the user database through the learning process. In addition, the corresponding biological feature is stored in each user account. In addition, the same user may have multiple unfinished watching movies. Therefore, each movie and the time parameter of the broadcasting status are correspondingly recorded for different users.

FIG. 4B is a schematic diagram illustrating how the broadcast device maintains the movie database. Referring to FIG. 4B, the movie is the main object to be maintained in the movie database. The movie database records and provides the accessory information corresponding to each movie.

According to the present invention, when the movie is being broadcasted and any user is not able to finish watching this movie, the movie database records that the user account corresponding to incomplete watching this movie, and the time parameter represents the broadcasting status of this movie. If there are multiple users who have not been finish watching the movie, the user accounts and the corresponding time parameters may further be recorded using indicator lists.

It is to be noted that the movie database may further store the accessory information (not shown) of the movie. The accessory information of the movie may be movie type, publisher, year, actor information, director, language, classification and the like. Each field of accessory information may contain many choices and may be adjusted according to the user's requirement. For example, the broadcast device provides default classifications of the horror movie and the comedy, and the user further adds the classifications of the science fiction movie, the cartoon movie and the like.

As mentioned hereinabove, the broadcast device provides the user database and the movie database, both of which are updated or modified dynamically according to detecting results of users' biological features and broadcasting status of movies.

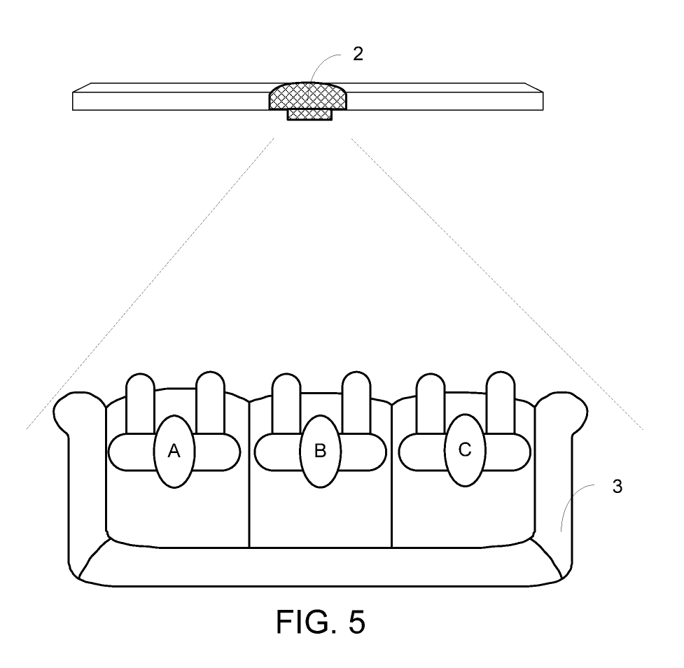

Next, it is assumed that the user has created the user information in the broadcast device in advance through the learning process. Thus, the usage of subsequently maintaining the user database facilitates. Several situations of the broadcast device applying the present invention will be described with reference to FIGS. 5, 6A, 6B, 6C, 7A, 7B, 7C, 8A, 8B, 8C, 9A, 9B, 9C, 10A, 10B, 10C, 10D, 11A, 11B, 11C, 11D, 12A, 12B, 12C and 12D. These situations illustrate several conditions when the number of the users watching the movie is changed. However, upon the practical application, the operation of the broadcast device is not restricted thereto.

For the sake of diagram, it is assumed that the broadcast device 2 has created the user database and the movie database.

FIG. 5 is a schematic diagram illustrating multiple users operating the broadcast device according to the embodiment of the present invention. For the sake of description, it is assumed that the detecting unit 23 is a camera facing a sofa 3 and can shoot the facial profile of the user who is sitting in front of the sofa 3. The dashed lines represent the detecting range of the camera for detecting the biological feature. Upon the practical application, the mounting position of the camera needs not to be consistent with the broadcast device 2.

In FIG. 5, it is assumed that the users A, B and C are watching a first movie I together. At this time, the broadcast device continuously broadcasts multimedia bitstream of the first movie I. Because the users A, B and C are in front of the broadcast device 2, the detecting unit 23 can continuously detect the biological features corresponding to the users A, B and C. That is, the detecting unit 23 continuously determines the detected biological features corresponding to the users A, B and C as present status. At this time, the control unit 25 controls the broadcast unit 21 to continuously broadcast the first movie I.

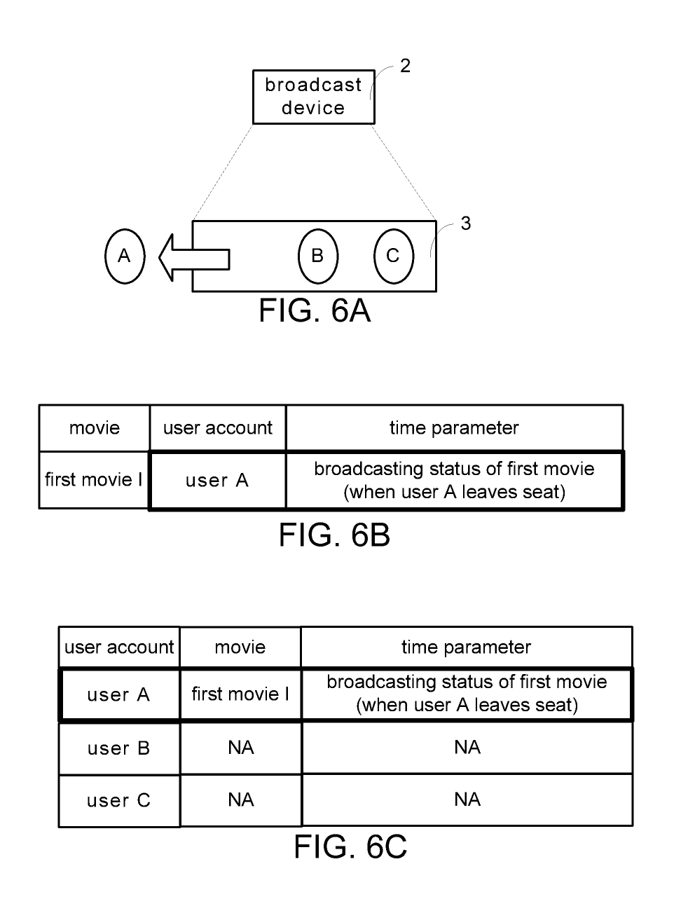

FIG. 6A is a schematic diagram illustrating that the user A leaves first in a case that the users A, B and C are watching the first movie together. Referring to FIG. 6A, when the user A leaves, the detecting unit 23 converts existing status of the detected facial features corresponding to the user A from a present status into a hidden status according to detecting results corresponding to the facial recognition features corresponding to the user A.

Regarding such the conversion of the detecting results, the control unit 25 is regarded as having the trigger condition corresponding to the user A being satisfied. At this time, the control unit 25 updates the contents of the movie database and the user database according to the broadcasting status of the first movie I. On the other hand, regarding the biological features corresponding to the users B and C, the detecting unit 23 continuously detects the biological features. Thus, the detecting unit 23 remains to determine existing statuses of the detected facial features corresponding to the users B and C as the present status.

FIG. 6B is a schematic diagram corresponding to the status of FIG. 6A and showing that the movie database is updated. Referring to FIG. 6B, the information, regarding the time parameter corresponding to the broadcasting status of the first movie I when the user A leaves, is updated in the movie database.

FIG. 6C is a schematic diagram corresponding to the status of FIG. 6A and showing that the user database is updated. Referring to FIG. 6C, the information, regarding the time parameter corresponding to the broadcasting status of the first movie I when the user A leaves, is updated in the user database.

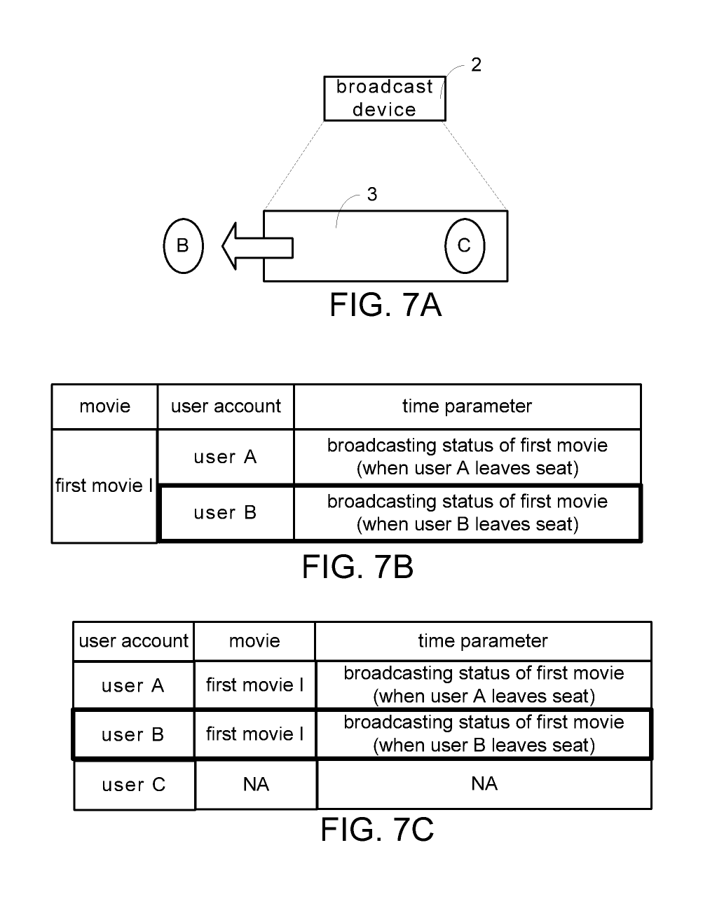

FIG. 7A is a schematic diagram following the condition of FIG. 6A and showing that the user B leaves. Referring to FIG. 7A, it is assumed that the user B also leaves the living room after the user A leaves the living room for a period of time.

Similarly, when the user B leaves, the existing status of the detected facial recognition features corresponding to the user B changes from the present status to the hidden status. Regarding such change of the detected facial recognition features, the control unit 25 regards the trigger condition corresponding to the user B being satisfied. At this time, the control unit 25 updates the contents of the movie database and the user database according to the broadcasting status of the first movie I. On the other hand, regarding the user C, the detecting unit 23 continuously detects the biological feature corresponding to the user C and determines existing status of the detected facial features corresponding to the user C as the present status.

FIG. 7B is a schematic diagram corresponding to the status of FIG. 7A and showing that the movie database is updated. Comparing FIG. 7B with FIG. 6B, the broadcast device 2 updates the time parameter, corresponding to the broadcasting status of the first movie I when the user B leaves, to the movie database.

FIG. 7C is a schematic diagram corresponding to the status of FIG. 7A and showing that the user database is updated. Comparing with FIG. 6C, the broadcast device 2 updates the time parameter, corresponding to the broadcasting status of the first movie I when the user B leaves, to the user database in FIG. 7C.

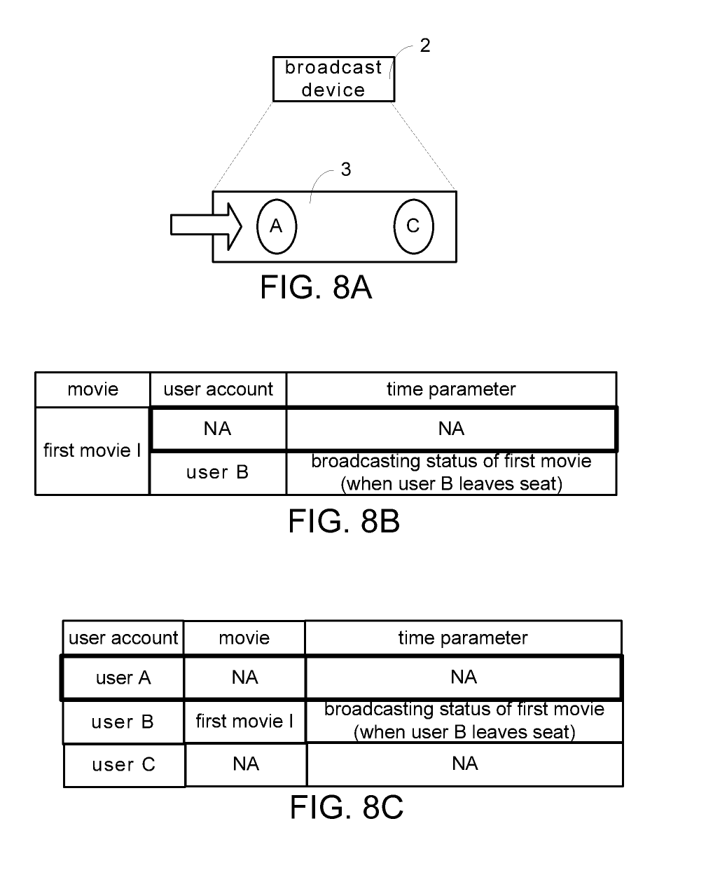

FIG. 8A is a schematic diagram following the condition of FIG. 7A and assuming that the user A is back to the seat. Referring to FIG. 8A, it is assumed that after the user B leaves the living room for a period of time, the user C still keeps in watching the first movie and the user A comes back to the living room again.

At this time, the broadcast device 2 will detect and obtain that the biological features corresponding to the user A is again detected. Thus, the existing status of the detected facial features corresponding to the user A changes from the hidden status to the present status. With such the conversion of the detecting results, the control unit 24 consequently determines that the recovery condition corresponding to the user A is satisfied. On the other hand, regarding the biological feature corresponding to the user C, the detecting unit 23 continuously detects. Thus, the existing status of the detected facial features corresponding to the user C remains as the present status. Even if the recovery condition corresponding to the user A has been established, it is assumed that the broadcast device 2 still continues broadcasting the first movie I in order to prevent the user C, who is watching the movie, from being interrupted.

FIG. 8B is a schematic diagram corresponding to the status of FIG. 8A and showing that the movie database is updated. Comparing FIG. 8B with FIG. 7B, the broadcast device 2 deletes the time parameter, corresponding to the broadcasting status of the first movie I when the user A leaves first, from the movie database.

FIG. 8C is a schematic diagram corresponding to the status of FIG. 8A and showing that the user database is updated. Comparing FIG. 8C with FIG. 7C, the broadcast device 2 deletes the time parameter, corresponding to the broadcasting status of the first movie I when the user A leaves first, from the user database.

It is to be noted that, in the condition when the recovery condition corresponding to the user A is satisfied but the user C still continuously watches the movie, the contents of the movie database and the user database may also be updated in different manners. For example, the time, regarding when the user A is back to the seat, is further stored in the time parameter fields of the movie database and the user database. Therefore, the watch-interrupt period of the user A is recorded in the movie database and the user database, and the user A can solely watch the contents of the movie in the watch-interrupt period in some other time. In other words, the update and use of the contents of the database may be applied by those skilled in the art.

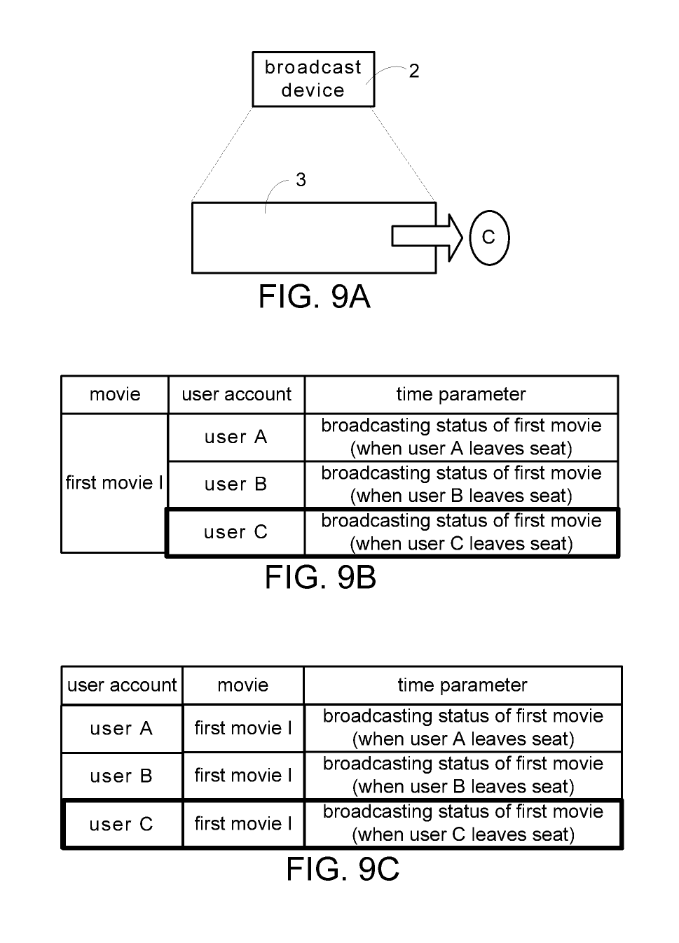

FIG. 9A is a schematic diagram following the condition of FIG. 7A and assuming that the user C leaves. In FIG. 9A, it is assumed that after the user B leaves, the user C also leaves the living room. At this time, the broadcast device 2 determines that no user is currently watching the first movie I according to the detecting results of the detecting unit 23. Therefore, the broadcast device 2 will automatically stop broadcasting the first movie I.

FIG. 9B is a schematic diagram corresponding to the status of FIG. 9A and showing that the movie database is updated. Comparing FIG. 9B with FIG. 7B, the broadcast device 2 adds the time parameter, corresponding to the broadcasting status of the first movie I when the user C leaves, to the movie database.

FIG. 9C is a schematic diagram corresponding to the status of FIG. 9A and showing that the user database is updated. Comparing FIG. 9C with FIG. 7C, the broadcast device 2 adds the time parameter, corresponding to the broadcasting status of the first movie I when the user C leaves, to the user database.

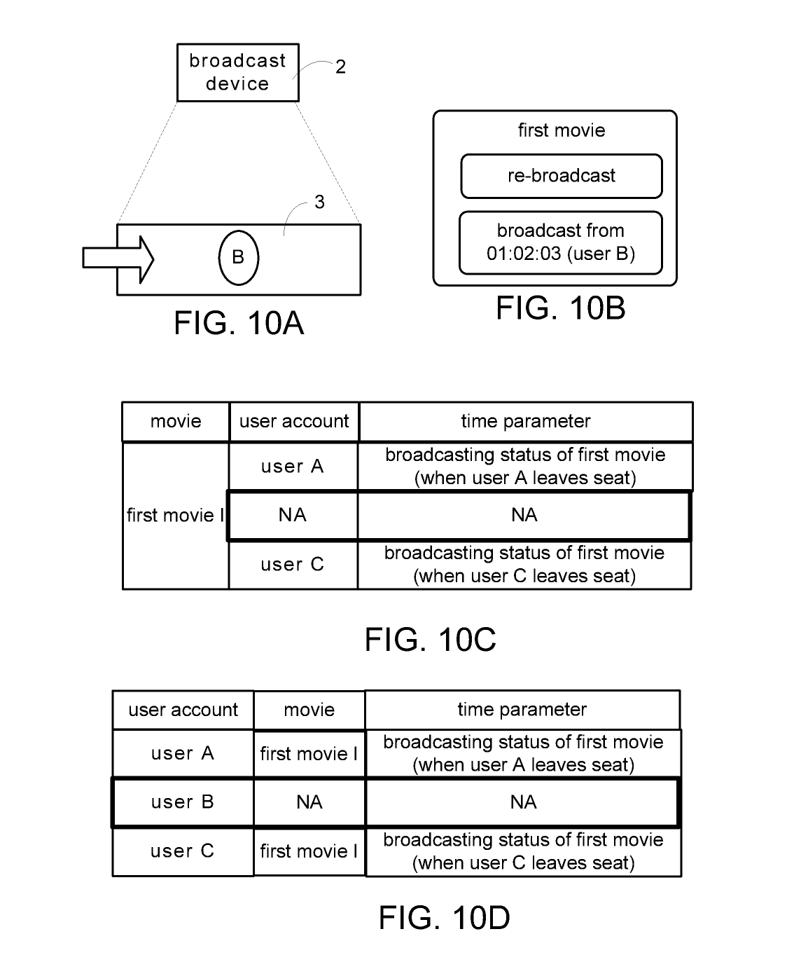

FIG. 10A is a schematic diagram following the condition of FIG. 9A and assuming that the user B is back to the seat. In FIG. 10A, it is assumed that the user B reselects to watch the first movie I when the user B is back to the seat. In addition, it is assumed that the user B solely uses the broadcast device 2.

FIG. 10B is a schematic diagram corresponding to the status of FIG. 10A and showing that the broadcast device displays a prompt frame through user interface. Referring to FIG. 10B, when the first movie I is selected, the control unit 25 obtains, according to the first movie I in the movie database, that the user B has previously watched but has not fully watched the first movie I. Therefore, the broadcast device 2 may utilize the user interface to display the prompt frame to inform the user B about the previous record of watching the first movie I by way of on-screen display (hereinafter, OSD).

At this time, the prompt frame may provide two options, one of which is to re-broadcast the first movie I from the beginning; and the other of which is to perform the frame broadcast according to the broadcast time (e.g., 01:02:03) recorded based on the broadcasting status of the first movie I when the user B left previously. Therefore, the user B may perform the selection according to his/her own requirement.

FIG. 10C is a schematic diagram corresponding to the status of FIG. 10A and showing that the movie database is updated. Referring to FIG. 10C, if the originally left user is back to the seat and selects to watch the first movie I again, the record regarding the user is cleared from the movie database.

FIG. 10D is a schematic diagram corresponding to the status of FIG. 10A and showing that the user database is updated. Comparing FIG. 10D with FIG. 9C, FIG. 10D further clears the time parameter, corresponding to the broadcasting status of the first movie I when the user B leaves the seat during the period of watching the first movie I, from the user database. Assuming that the user B finishes watching the first movie I at this time, the movie database and the user database are no longer updated.

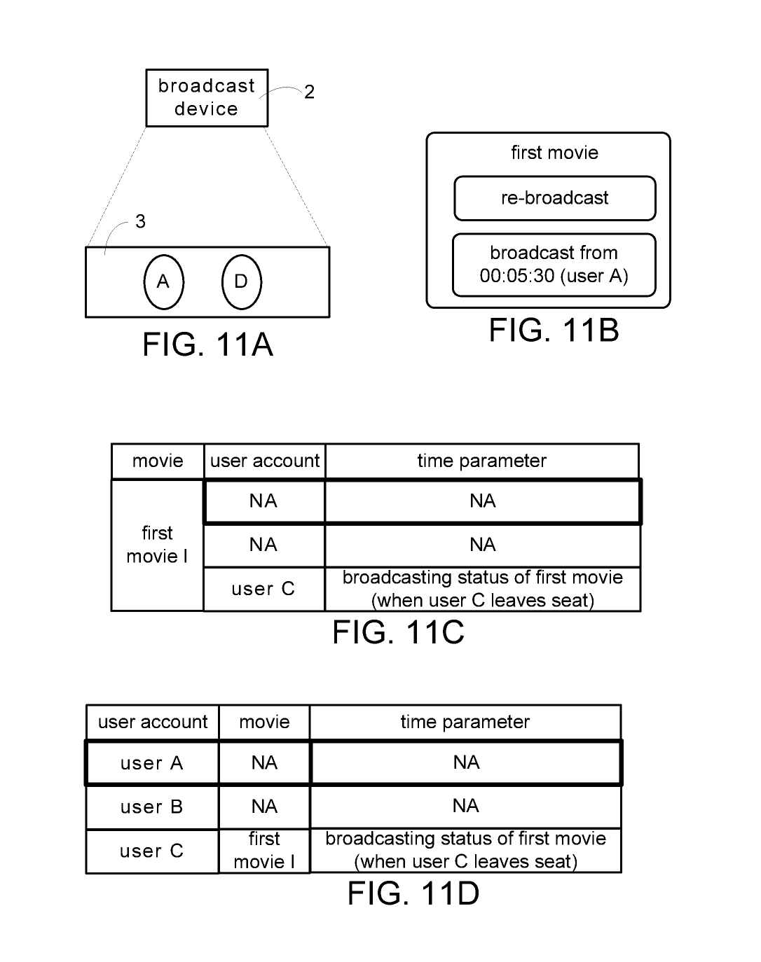

FIG. 11A is a schematic diagram following the condition of FIG. 10A and assuming that the user A again watches the first movie I. Referring to FIG. 11A, it is assumed that the user A wishes to watch the first movie I again on a certain day after a period of time has elapsed. Herein, it is assumed that the user D also wishes to watch the first movie I together with the user A, but the user account and the biological features corresponding to the user D have not been created in the user database.

Because the user account of the user D has not been created, the broadcast device 2 will not record the time parameter, corresponding to the broadcasting status of the first movie I when the user D leaves, even if the user D leaves the seat during the watching process.

FIG. 11B is a schematic diagram corresponding to the status of FIG. 11A and showing that the broadcast device displays the prompt frame. Referring to FIG. 11B, the users select to watch the first movie I at first, and the broadcast device obtains the information shown in FIG. 10C according to the movie database. That is, the user A and the user C had watched the first movie I, and the time parameters of the broadcasting status of the first movie I when the users A and C previously watched the first movie I are consequently obtained.

The broadcast device 2 detects the biological features corresponding to the users A and D through the detecting unit 23. The broadcast device 2 obtains that the user A had previously watched but had not fully watched the first movie I according to the record of the first movie I in the movie database. Therefore, the broadcast device 2 displays the prompt frame through the user interface to inform the users A and D. In other words, the contents of the prompt frame are determined according to the contents of the movie database and the detecting results of the biological feature.

At this time, the prompt frame may provide two options, one of which is to re-broadcast the first movie from the beginning, and the other of which is to perform the frame broadcast according to the broadcast time (e.g., 00:05:30), recorded according to the broadcasting status of the first movie I when the user A left previously. Therefore, the users A and D can together determine to select which option.

FIG. 11C is a schematic diagram corresponding to the status of FIG. 11A and showing that the movie database is updated. In FIG. 11C, the time parameter, corresponding to the broadcasting status of the first movie I when the user A watches the first movie I, is further cleared from FIG. 10C.

FIG. 11D is a schematic diagram corresponding to the status of FIG. 11A and showing that the user database is updated. In FIG. 11D, the time parameter, corresponding to the broadcasting status of the first movie I when the user A watches the first movie I, is further cleared from FIG. 10D.

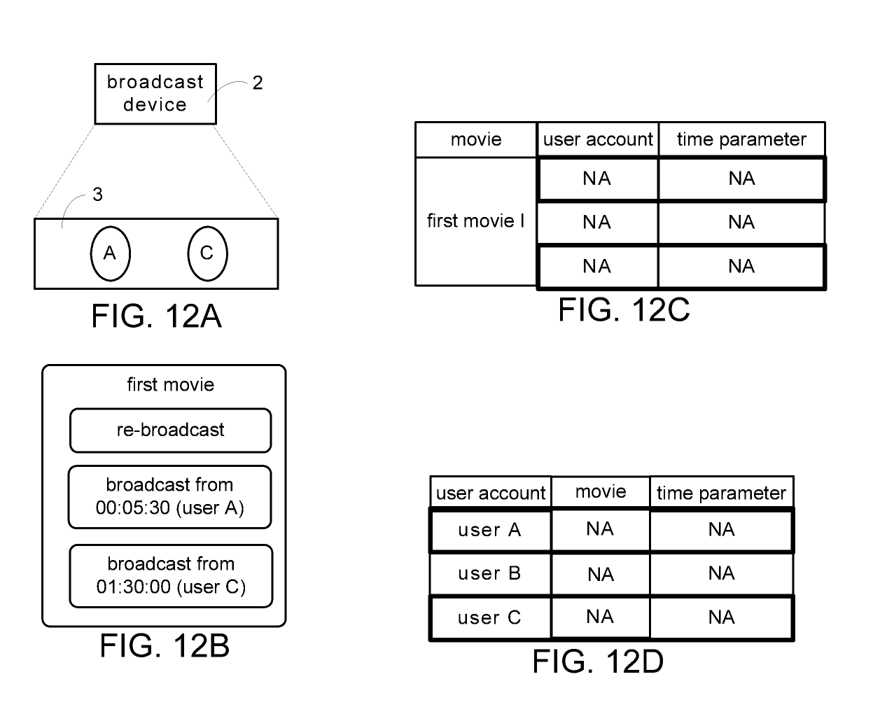

FIG. 12A is a schematic diagram following the condition of FIG. 10A and showing that the users A and C again watch the first movie concurrently. In FIG. 12A, it is assumed that the users A and C wish to watch the first movie I together after a period of time has elapsed.

FIG. 12B is a schematic diagram corresponding to the status of FIG. 12A and showing that the broadcast device displays the prompt frame through the user interface.

The broadcast device 2 detects and obtains the biological features corresponding to the users A and C through the detecting unit 23. In addition, when the first movie I is selected, it is obtained that the users A and C had previously watched the first movie I but had not finished watching according to the record of the first movie I in the movie database. Therefore, the broadcast device 2 may display the prompt frame through the user interface to inform the users A and C. In other words, the contents of the prompt frame are determined according to the contents of the movie database and the detecting results of the biological feature.

At this time, the prompt frame may provide three options, wherein the first option is to re-broadcast the first movie I from the beginning; the second option is to perform the frame broadcast when the user A left previously; and the third option is to perform the frame broadcast when the user C left previously.

In certain applications, the represented contents of the prompt frame may also further provide other information according to the application requirement. For example, the watching date is additionally recorded to prompt the user to know the creation date of the pause time record, and the like.

FIG. 12C is a schematic diagram corresponding to the status of FIG. 12A and showing that the movie database is updated. In FIG. 12C, the time parameter, corresponding to the broadcasting status of the first movie I when the users A and C watch the first movie I, is further cleared from FIG. 10C.

FIG. 12D is a schematic diagram corresponding to the status of FIG. 12A and showing that the user database is updated. In FIG. 12D, the time parameter, corresponding to the broadcasting status of the first movie I when the users A and C watch the first movie I, is cleared from FIG. 10D.

In summary, the broadcast device 2 still continuously detects the biological feature when broadcasting the first movie I. If the results of the broadcast device 2 detecting the user's biological feature are continuously kept unchanged, then the broadcast device 2 keeps in broadcasting the first movie I.

Alternatively, when the existing status of the detected user's biological features is changed from the original present status to the hidden status, the broadcast device 2 will determines the trigger condition being satisfied. At this time, the broadcast device 2 determines that the user has left, and thus needs to create the time parameter according to the broadcasting status of the first movie I watched by the user. At this time, the control unit 25 controls the storage unit 27 to update the user database and the contents of the movie database according to the broadcasting status of the multimedia bitstream.

On the other hand, if the existing status corresponding to user's biological feature is changed from the hidden status to the present status, the broadcast device 2 determines that the user has been back to the seat. At this time, the control unit 25 determines that the recovery condition is satisfied. Therefore, the control unit 25 instructs the broadcast unit 21 to broadcast the multimedia bitstream according to the user database and the contents of the movie database. In addition, the control unit 25 may also update the contents of the user database and the movie database.

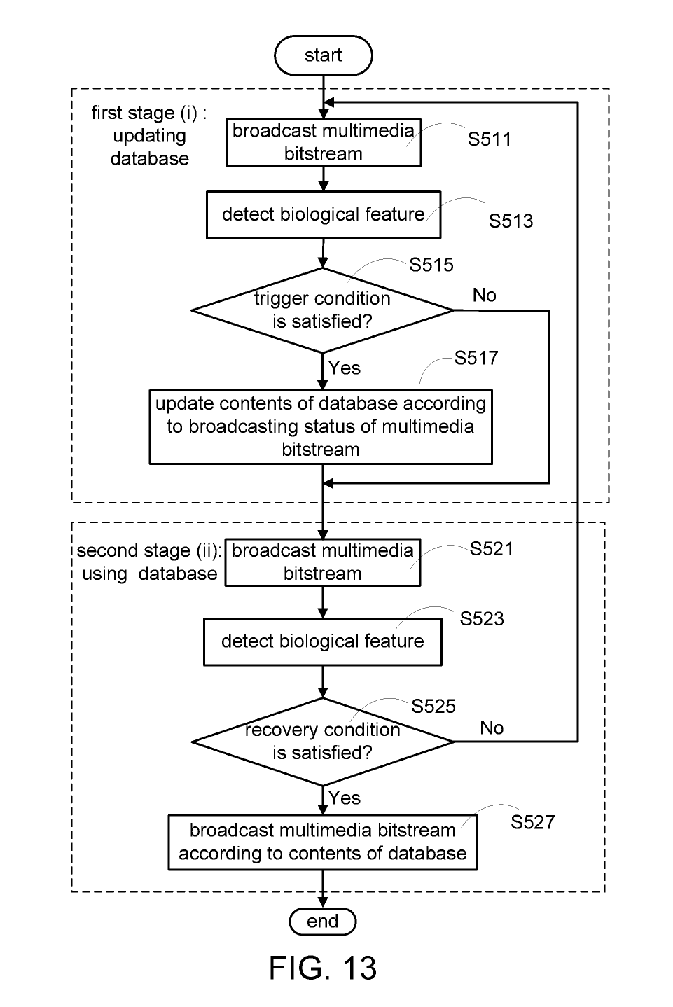

As mentioned above, the broadcast device 2 may create and store the corresponding relationship between the user account and the biological feature through the learning process. The execution of the learning process will not be repeatedly described herein. Next, the application conditions are compiled to obtain the broadcast flow of FIG. 13.

FIG. 13 is a flow chart showing a broadcast method of the present invention.

When the broadcast device of the present invention performs the broadcast flow, two stages are divided. The two stages include a first stage (i) of updating the database; and a second stage (ii) of using the database. The second stage (i) of updating the database represents the condition where the user interrupts watching the movie; and the second stage (ii) of using the database represents the condition where the user returns and watches the movie again.

First, in the first stage (i) of updating the database, the database records the time parameter regarding when the user leaves the seat. The control unit 25 controls the broadcast unit 21 to broadcast the multimedia bitstream (step S511). In addition, the detecting unit 23 continuously detects the biological feature (step S513). At this time, the control unit 25 determines whether the detecting results of the biological feature match to the trigger condition or not (step S515).

If the determination result of the step S515 is that the detected result matches to the trigger condition, the control unit 25 obtains the broadcasting status of the broadcast unit 21 of the multimedia bitstream. In addition, contents such as the time parameter, corresponding to the broadcasting status of the multimedia bitstream, are updated to the movie database and the user database provided by the storage unit 27 (step S517).

On the other hand, if the determination result of the step S515 is negative, the second stage (ii) of using the database is entered. In the second stage, the database provides the time parameter, regarding when the user previously left the seat, to the control unit 25 and the broadcast unit 21.

The control unit 25 controls the broadcast unit 21 to keep broadcasting the multimedia bitstream (step S521), and controls the detecting unit 23 to detect the biological feature (step S523). According to the biological feature obtained by detecting in the step S523, the control unit 25 determines whether the recovery condition is satisfied (step S525). In addition, when the recovery condition is satisfied, the control unit 25 controls the broadcast unit 21 to broadcast the multimedia according to the contents (e.g. time parameters) recorded in the database (step S527). If the determination result of the step S525 is negative, the control unit 25 controls the broadcast unit 21 to continue broadcasting the multimedia bitstream. Next, the broadcast device 2 returns to the first stage (i) of updating the database.

It is to be noted that when the broadcast device 2 is operating, the order of the two stages is not necessarily particularly restricted. In fact, the two stages may be performed in an alternating or parallel manner.

When there are multiple users watching the movie together, the procedure further determines the trigger conditions and the recovery conditions for different users. For example, the step S513 detects the biological features corresponding to multiple users, and performs the determination according to whether these biological features match to the trigger condition, respectively. Similarly, the step S523 also detects the biological features corresponding to multiple users and performs the determination according to whether these biological features match to the recovery condition, respectively.

It is assumed that the users A and B watch the movie together. Therefore, the trigger condition corresponding to the user A is equivalent to the case when the user A leaves (the existing status of detected biological features corresponding to the user A changes from the present status to the hidden status). On the other hand, the recovery condition corresponding to the user A is equivalent to the case when the user A is back to the seat (the existing status of detected biological features corresponding to the user A changes from the hidden status to the present status).

Also, the trigger condition corresponding to the user B is equivalent to the case when the user B leaves (the existing status of the detected biological features corresponding to the user B changes from the present status to the hidden status), and the recovery condition corresponding to the user B is equivalent to the case when the user B is back to the seat (the existing status of the detected biological features corresponding to the user B changes from the hidden status to the present status).

In short, the broadcast device 2 creates the corresponding trigger condition and recovery condition according to the user who is actually watching. The numbers of the trigger conditions and the recovery conditions correspond to the number of users who actually watch the movie.

As mentioned hereinabove, the DTS usually represents the decoding order in the movie bitstream. Therefore, as long as the DTS is obtained, the broadcast device knows which GOP should be started and broadcasted. Therefore, when the broadcast device 2 records the time parameter, the DTS is used to represent the broadcasting status of the movie. However, the representation of the DTS is not intuitive to the user. Therefore, the time parameters stored in the movie database and the user database are further converted into the pause time upon movie broadcasting according to the DTS.

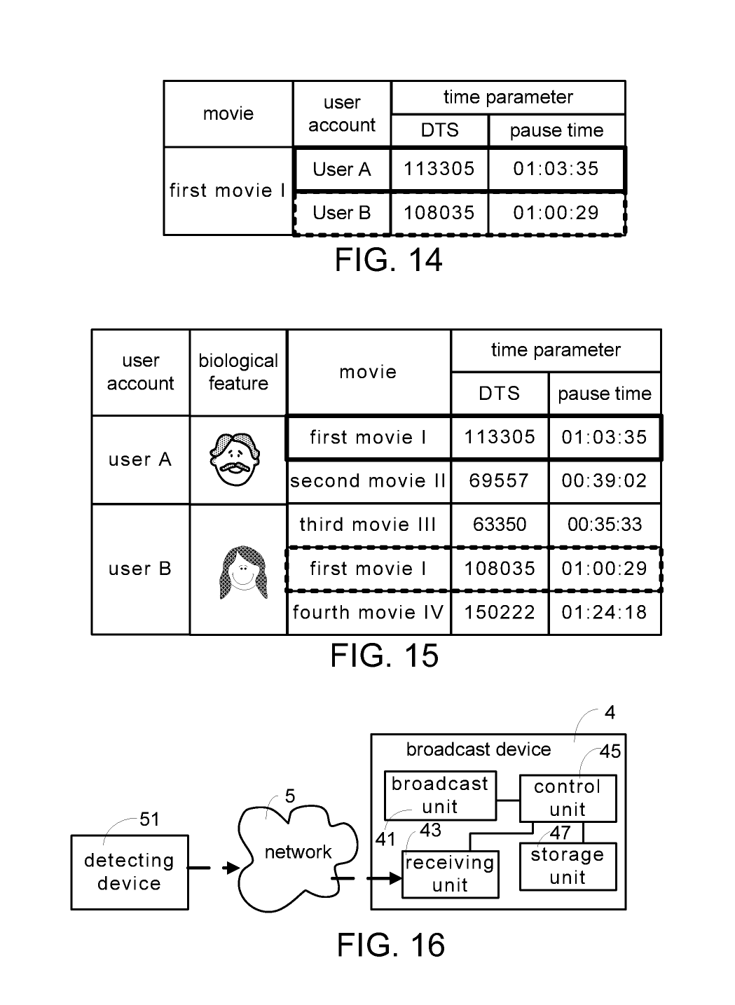

FIG. 14 is a schematic diagram illustrating that the broadcast device is maintaining the movie database. Herein, it is assumed that the users A and B had ever watched the first movie I but had not finished watching. Therefore, the movie database records the DTS and the pause time when the two users watched the first movie I.

When the user A leaves, the broadcast timing of the first movie I is at the position 01:03:35, and the DTS corresponding to the time point is the number of 113305. When the user B leaves, the pause time of the first movie I is at the position 01:00:29, and the DTS corresponding to the pause time (01:00:29) is the number 108035.

It is to be noted that timing of conversion between the DTS and the pause time needs not to be restricted. For example, the pause time may be obtained by conversion in advance and then stored in the storage unit. Alternatively, the pause time may be obtained by conversion according to the DTS in the database only when the broadcast device 2 needs to display the prompt frame.

FIG. 15 is a schematic diagram illustrating how the broadcast device maintains the user database. FIG. 15 illustrates that even if the user had ever watched multiple movies but had not finished watching these movies, these watching records are still completely stored.

The movies that have not been fully watched by the user A are the first movie I and the second movie II. The pause time of the user A watching the first movie I is 01:03:35, and the DTS of that is 113305. The pause time of the user A watching the second movie II is 00:39:02, and the DTS of that is 69557.

The movies that have not been fully watched by the user B are the third movie III, the first movie I and the fourth movie IV. The pause time of the user B watching the third movie III is 00:35:33, and the DTS of that is 63350. The pause time of the user B watching the first movie I is 01:00:29, and the DTS of that is 108035. The pause time of the user B watching the fourth movie IV is 01:24:18, and the DTS of that is 150222.

Therefore, if the user A is free, he or she can operate the broadcast device 2 to select to watch the first movie I and/or the second movie II which are not fully watched previously. Similarly, if the user B is free, he or she can operate the broadcast device 2 to select the movies which are not fully watched previously, i.e. the third movie III, the first movie I and/or the fourth movie IV.

In summary, the broadcast device according to the embodiment of the present invention provides the operation flow by which the user can operate very naturally and freely. Once the user leaves the location in front of the screen, the broadcast device 2 automatically records the pause time of the movie. At the next time when the movie is broadcasted, the broadcast device 2 automatically recognizes whether the user has the record of the movie that is not fully watched. In addition, the broadcast device 2 may also automatically display the prompt message so that the user confirms whether to start to watch the movie from the previously paused timing. This design dramatically reduces inconveniences caused by using the remote controller. Furthermore, the broadcast device 2 provides adaptive recording function so that the other users are not interfered while watching.

It is to be noted that an independent detecting device 51 is used in conjunction with a broadcast device 4 in another embodiment of the present invention.

FIG. 16 is a schematic diagram illustrating a detecting device working in conjunction with the broadcast device. Referring to FIG. 16, the detecting device 51 of this embodiment is disposed remotely, and is in communication with the broadcast device 4 through a network 5. When this arrangement is adopted, the broadcast device 4 further includes a receiving unit 43. In FIG. 16, a control unit 45 is electrically connected to a broadcast unit 41, a storage unit 47 and the receiving unit 43. The receiving unit 43 receives the biological feature detected by the detecting device 51. After obtaining the detected results, the receiving unit 43 transmits the detecting results to the control unit 45. The uses of other elements are similar to those mentioned hereinabove, and will not be further described.

It is to be noted that even if the movie broadcasting serves as the example of the multimedia bitstream, the similar pause control may also be applied to other types of multimedia bitstreams such as music broadcast bitstreams, teaching programs, stored digital program bitstreams and the like.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A broadcast device, comprising:
a broadcast unit, for broadcasting a multimedia bitstream;
a storage unit, for storing a database;
a detecting unit, electrically connected to the broadcast unit, for detecting a first biological feature; and
a control unit, electrically connected to the broadcast unit and the detecting unit, for
updating contents of the database according to a broadcasting status of the multimedia bitstream when the detected first biological feature satisfies a first trigger condition; and
controlling the broadcast unit to broadcast the multimedia bitstream according to the contents of the database when the detected first biological feature satisfies a first recovery condition.

2. The broadcast device according to claim 1, wherein:
the first trigger condition represents that the detected first biological feature changes from a present status to a hidden status; and
the first recovery condition represents that the detected first biological feature changes from the hidden status to the present status.

3. The broadcast device according to claim 1, wherein:
when the first trigger condition is satisfied, the control unit updates the contents of the database according to a time parameter corresponding to the broadcasting status of the multimedia bitstream; and
when the first recovery condition is satisfied, the control unit controls the broadcast unit to broadcast the multimedia bitstream according to the time parameter.

4. The broadcast device according to claim 1, wherein the detecting unit detects a second biological feature and the control unit
updates the contents of the database according to the broadcasting status of the multimedia bitstream when the detected second biological feature satisfies a second trigger condition; and
controls the broadcast unit to broadcast the multimedia bitstream according to the contents of the database when the detected second biological feature satisfies a second recovery condition.

5. The broadcast device according to claim 4, wherein:
the second trigger condition represents that the detected second biological feature changes from a present status to a hidden status; and
the second recovery condition represents that the detected second biological feature changes from the hidden status to the present status.

6. The broadcast device according to claim 1, wherein the control unit creates a corresponding relationship between a first user account and the first biological feature in the database through a learning process.

7. The broadcast device according to claim 1, wherein the first biological feature is an iris recognition feature or a facial recognition feature.

8. The broadcast device according to claim 1, wherein the detecting unit actively detects the first biological feature.

9. A broadcast system, comprising:
a detecting device, for detecting and transmitting a first biological feature; and
a broadcast device, comprising:
a receiving unit, in communication with the detecting device, for receiving the detected first biological feature;
a broadcast unit, for broadcasting a multimedia bitstream;
a storage unit, for storing contents of a database; and
a control unit, electrically connected to the receiving unit, the broadcast unit and the detecting device, for
updating contents of the database according to broadcasting status of the multimedia bitstream when the detected first biological feature satisfies a first trigger condition; and
controlling the broadcast unit to broadcast the multimedia bitstream according to the contents of the database when the detected first biological feature satisfies a first recovery condition.

10. The broadcast system according to claim 9, wherein:
the control unit updates the contents of the database according to a time parameter corresponding to the broadcasting status of the multimedia bitstream when the first trigger condition is satisfied; and
the control unit controls the broadcast unit to broadcast the multimedia bitstream according to the time parameter when the first recovery condition is satisfied.

11. The broadcast system according to claim 9, wherein the first biological feature is an iris recognition feature or a facial recognition feature, and the detecting device actively detects the first biological feature.

12. A broadcast method applied to a broadcast device, the broadcast method comprising the steps of:
broadcasting a multimedia bitstream;
detecting a first biological feature;
updating contents of a database according to broadcasting status of the multimedia bitstream when the detected first biological feature satisfies a first trigger condition; and
broadcasting the multimedia bitstream according to contents of the database when the detected first biological feature satisfies a first recovery condition.

13. The broadcast method according to claim 12, wherein:
the first trigger condition represents that the detected first biological feature changes from a present status to a hidden status; and
the first recovery condition represents that the detected first biological feature changes from the hidden status to the present status.

14. The broadcast method according to claim 12, wherein the step of updating the contents of the database according to the broadcasting status of the multimedia bitstream represents step of:
updating the contents of the database according to a time parameter corresponding to the broadcasting status of the multimedia bitstream.

15. The broadcast method according to claim 14, wherein the step of controlling the broadcast device to broadcast the multimedia bitstream according to the contents of the database represents step of:
broadcasting the multimedia bitstream according to the time parameter.

16. The broadcast method according to claim 12, further comprising the steps of:
detecting a second biological feature;
updating the contents of the database according to the broadcasting status of the multimedia bitstream when detected second biological feature satisfies a second trigger condition; and
broadcasting the multimedia bitstream according to contents of the database when the detected second biological feature satisfies a second recovery condition.

17. The broadcast method according to claim 16, wherein:
the second trigger condition represents that detected second biological feature changes from a present status to a hidden status; and
the second recovery condition represents that the detected second biological feature changes from the hidden status to the present status.

18. The broadcast method according to claim 12, wherein the first biological feature is an iris recognition feature or a facial recognition feature.

19. The broadcast method according to claim 12, wherein the step of detecting the first biological feature is performed actively.
